(19) United States
(12) Patent Application Publication
(10) Pub. No.: US 2014/0209317 A1
(43) Pub. Date: Jul. 31, 2014

(54) MOBILE WORKFLOW ORCHESTRATION AND JOB EXECUTION FOR HYDROCARBON RECOVERY OPERATIONS

(71) Applicant: HALLIBURTON ENERGY SERVICES, INC., HOUSTON, TX (US)

(72) Inventors: Ron Dirksen, Spring, TX (US); Ben Musgrave, Houston, TX (US); Bhargav Hariprasad Patel, Houston, TX (US); Victor Alexander Artiga, Kingwood, TX (US); Kiran Gopala Reddy Sunanda, Kingwood, TX (US); William David Bethancourt, Houghton, MI (US); Cili Sun, Sugar Land, TX (US); Marcus Leo Avery, Houston, TX (US)

(73) Assignee: HALLIBURTON ENERGY SERVICES, INC., HOUSTON, TX (US)

(21) Appl. No.: 14/165,184

(22) Filed: Jan. 27, 2014

Related U.S. Application Data
(60) Provisional application No. 61/758,858, filed on Jan. 31, 2013.

(51) Int. Cl. E21B 47/12; E21B 43/16

(52) U.S. Cl. CPC E21B 47/12; E21B 43/16
USPC 166/369

(57) ABSTRACT

An example method for mobile workflow orchestration and job execution for a hydrocarbon recovery operation may include generating a workflow corresponding to the hydrocarbon recovery operation and providing the workflow to a first information handling system located at the site of the hydrocarbon recovery operation. The workflow may also be provided to a second information handling system remote from the site of the hydrocarbon recovery operation. Information regarding the workflow may be received from the first information handling system, and the workflow at the second information handling system may be updated based, at least in part, on the information received from the first information handling system.

### CROSS-REFERENCE TO RELATED APPLICATION

This application claims the benefit of U.S. Provisional Application No. 61/758,858, filed Jan. 31, 2013, which is incorporated herein by reference for all purposes.

### BACKGROUND

The present disclosure relates generally to downhole drilling operations and, more particularly, to mobile workflow orchestration and job execution for hydrocarbon recovery operations.

As hydrocarbon recovery operations, including well drilling, become more complex, the number of tasks that must be accomplished by on-site personnel increases. Likewise, the complexity of each task and the information required to complete each task increases. Keeping track of this information can be difficult, as can actively monitoring the steps that have been completed to ensure compliance with best practices.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features.

FIG. 1 is a functional diagram illustrating a workflow architecture according to aspects of the present disclosure.

FIG. 2 is a diagram illustrating example data structures for the workflow architecture, according to aspects of the present disclosure.

FIG. 3 is a diagram illustrating an example user interface within a workflow architecture according to aspects of the present disclosure.

FIG. 4 is a flowchart illustrating an example workflow orchestration process according to aspects of the present disclosure.

FIG. 5 is a block diagram of an example information handling system, according to aspects of the present disclosure.

While embodiments of this disclosure have been depicted and described and are defined by reference to exemplary embodiments of the disclosure, such references do not imply a limitation on the disclosure, and no such limitation is to be inferred. The subject matter disclosed is capable of considerable modification, alteration, and equivalents in form and function, as will occur to those skilled in the pertinent art and having the benefit of this disclosure. The depicted and described embodiments of this disclosure are examples only, and not exhaustive of the scope of the disclosure.

### DETAILED DESCRIPTION

Illustrative embodiments of the present invention are described in detail below. In the interest of clarity, not all features of an actual implementation are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of the present disclosure.

To facilitate a better understanding of the present disclosure, the following examples of certain embodiments are given. In no way should the following examples be read to limit, or define, the scope of the disclosure. Embodiments of the present disclosure may be applicable to drilling operations that include, but are not limited to, target (such as an adjacent well) following, target intersecting, target locating, well twinning such as in SAGD (steam assist gravity drainage) well structures, drilling relief wells for blowout wells, river crossings, construction tunneling, as well as horizontal, vertical, deviated, multilateral, u-tube connection, intersection, bypass (drill around a mid-depth stuck fish and back into the well below), or otherwise nonlinear wellbores in any type of subterranean formation. Embodiments may be applicable to injection wells, stimulation wells, and production wells, including natural resource production wells such as hydrogen sulfide, hydrocarbons or geothermal wells; as well as borehole construction for river crossing tunneling and other such tunneling boreholes for near surface construction purposes or borehole u-tube pipelines used for the transportation of fluids such as hydrocarbons. Embodiments described below with respect to one implementation are not intended to be limiting.

The terms “couple” or “couples” as used herein are intended to mean either an indirect or a direct connection. Thus, if a first device couples to a second device, that connection may be through a direct connection or through an indirect mechanical or electrical connection via other devices and connections. Similarly, the term “communicatively coupled” as used herein is intended to mean either a direct or an indirect communication connection. Such connection may be a wired or wireless connection such as, for example, Ethernet or local area network (LAN). Thus, if a first device communicatively couples to a second device, that connection may be through a direct connection, or through an indirect communication connection via other devices and connections.

For purposes of this disclosure, an information handling system or computing system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communication with external devices as well as various input and output (I/O) devices, such as a keyboard, a mouse, and a video display. The information handling system may also include one or more buses operable to transmit communications between the various hardware components. Example information handling systems include server systems, computer terminals, handheld computing devices, tablets, smartphones, etc.

According to aspects of the present disclosure, systems and methods for mobile workflow orchestration and job execution in hydrocarbon recovery operations are described herein. In certain embodiments, the systems and methods may use a workflow architecture to generate, manage, and display a workflow required at a rig site of the hydrocarbon recovery operation. A workflow may comprise a chronological listing of major tasks of a particular hydrocarbon recovery operation, such as drilling a well, and may include industry standard tasks, proprietary tasks, tasks required by regulatory agencies, etc. Each of the major tasks may have corresponding steps, which also may be listed and displayed chronologically. The major tasks and corresponding steps may have associated data structures stored in a central database, the data structures containing information about the tasks and steps. Visual representations of the workflow may be generated based, at least in part, on the data structures and displayed in user interfaces for different types of users, with certain users being able to modify the data structures through the user interfaces. The workflow data structures, corresponding visual representations, and user interface may be used to verify the completion of tasks and to define the personnel responsible for certain tasks, the order in which the tasks are performed, and the manner in which the tasks are accomplished.

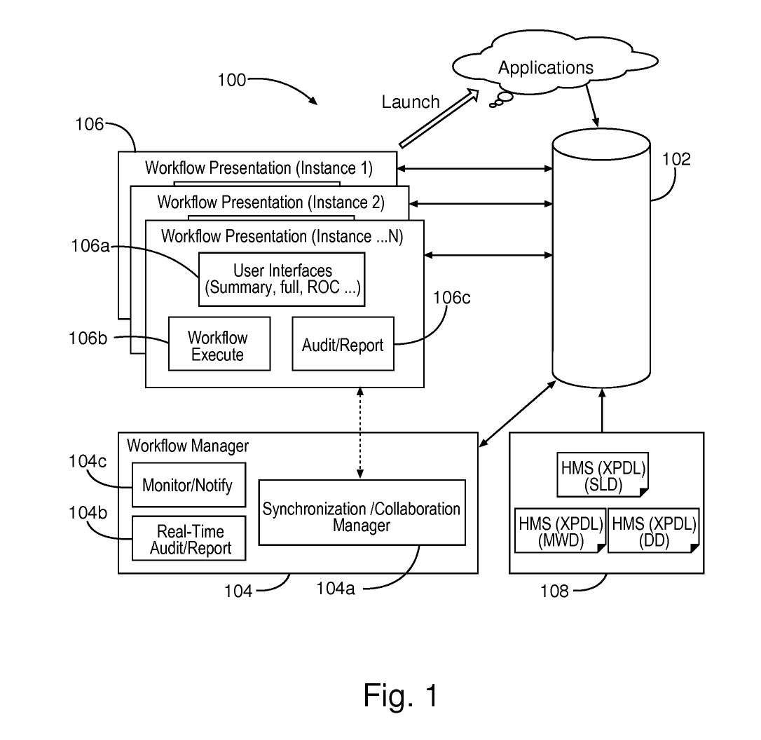

FIG. 1 is a functional diagram illustrating an example workflow architecture system 100, according to aspects of the present disclosure. In the embodiment shown, the system 100 includes a central database 102, a workflow manager application 104, and a plurality of workflow presentation application instances 106. Each of the centralized database 102, the workflow manager application 104, and the plurality of workflow presentation application instances 106 may be communicably coupled via a dedicated network, the internet, or some combination of the two.

In certain embodiments, the applications and database may be implemented on a variety of different information handling systems. For example, the central database 102 may be implemented on one or more server systems that are located together in a data center or physically separated but logically connected via a network. The workflow manager application 104 may comprise a software application that is run on an information handling system located “on-site” where the drilling operation is underway. The workflow presentation application instances 106 may comprise similar software applications running simultaneously on multiple information handling systems of one ore multiple different types (e.g., smartphone, laptops, tablets, etc.) located at or away from the site of the drilling operation, allowing users to monitor the progress of the drilling operation remotely.

As used herein, a software application may comprise a set of instructions that, when executed by a processor in an information handling system, causes the processor to perform certain functions or actions. A software application may be stored and run locally at an information handling system (e.g., in the hard drive of a personal computer). A software application also may be stored and run remotely through the central database 102 with the information handling system functioning as a “client” of the database 102, as may be the case with the workflow presentation application instances 106 and their corresponding information handling systems.

In certain embodiments, a workflow may be generated for a hydrocarbon recover operation. Generating the workflow may comprise storing workflow data structures corresponding to at least one hydrocarbon recovery operation at the central database 102. The data structures may be characterized by a data storage scheme that is implemented in the central database 102 to store and organize tasks and steps of a workflow. In certain embodiments, a workflow for a particular operation may be generated as a group of linked data structures, with each major task and each step comprising a different data structure, and the data structures for the major tasks and corresponding steps linked in chronological order. Each of the data structures may also store information regarding the performance of the corresponding major task or step and a status indicator for the corresponding major task or step.

The generated workflow may be provided to one or more information handling systems within the system 100. In certain embodiments, providing the workflow to an information handling system may comprise generating a visual representation of the workflow in a user interface of the information handling system. In the embodiment shown, the workflow presentation application instances 106 may comprise software application instances running on one or more information handling systems that may provide the workflows. Each instance 106 may comprise a user interface 106a, a workflow executable application 106b, and an audit/report generator 106c, all of which may be separate software applications or subroutines of the instance. In certain embodiments, the workflow executable application 106b may access or receive copies of the data structures for a given workflow from the central database and generate a visual representation of the workflow in the user interface 106a based, at least in part, on the data structures. Each of the active workflow presentation application instances 106 may generate and view the visual representations of the workflow simultaneously, based on the data structures stored in the central database 102. As will be described below, this may allow multiple users to monitor and interact with the workflow, including real-time updates to the workflow.

In addition to displaying a visual representation of the workflow, the user interface 106a may further display a current stage of the workflow, receive input from a user, and allow for management of the workflow based on a user-type of the user associated with a particular workflow presentation application instance. In certain embodiments, the user interface 106a may comprise graphical representations of information from the data structures corresponding to the tasks and steps of the workflow. Users may access and modify the workflow and corresponding data structures by interacting with the graphical representations within the user interface 106a, as will be described below.

In certain embodiments, the workflow executable application 106b may identify when a graphical representation has been modified, receive information regarding the workflow based on the modification, and communicate the information to the central database 102, where it can be stored with the data structure for the workflow and communicated to other ones of the workflow presentation application instances 106. The received information regarding the workflow may include, for example, a indication that a task has been completed, such as by checking a box in the user interface; notes corresponding to actions taken with respect to a task or step in a text box within the user interface 106a; documents associated with the performance of a task or step; or other information as may be required to complete one of the major tasks or steps. Once received and stored in the central database 102, the information may be promulgated to all active workflow presentation application instances 106, which may update the corresponding workflow visual representations, so that other users can view up-to-date information regarding the progress of the hydrocarbon recovery operation.

As described above, each of the active workflow presentation application instances 106 may be associated with a user. The user may be identified based on login credentials that are entered into the user interface 106a and verified by either the workflow manager application 104 or central database 102 using an access list stored in workflow manager application 104 or central database 102. In certain embodiments, each of the users may be characterized by a user-type that may affect the extent to which a given user can view and interact with the visual representations in the user interface 106a. Example user-types include customer, field engineer, field manager, well planner, etc.

A “customer” user-type may be assigned to someone for whom the drilling operation is being completed but that does not actively participate in the operation. Accordingly, a “customer” may be able to view but not modify the workflow through the user interface 106a. A “field engineer” user-type may be assigned to someone who is responsible for accomplishing tasks or steps in the drilling operation, and may allow for the user to modify portions of the workflow necessary to indicate completion of the tasks or steps for which the “field engineer” is responsible, but may not allow the user to modify other portions of the workflow, such as those that require managerial or supervisory approval. Those portion may be associated with a different user-type, such as “field manager.” Additionally, a limited group, such as a “well planner” user type, may be able to add or delete tasks and steps from a workflow.

In certain embodiments, the completion of a task or step of a workflow may trigger the generation of an audit or report regarding the actions taken with respect to the completion of the task or step. The audit or report may allow for managerial or supervisory approval of the actions taken with respect to the task or step, to ensure compliance with regulatory best practices. The workflow executable application 106b may determine when a task has been completed, for example, and generate a command to the audit/report generator 106c to generate a report. The contents of the reports may be included in the command from the workflow executable application 106b, or may be determined by the audit/report generator 106c. The audit/report generator 106c may, for example, retrieve data corresponding to a given task or step from the information handling system on which the audit/report generator 106c is running, and may either provide the report to the workflow executable application 106b to be communicated to the central database 102, or may itself communicate the report to the central database 102. The report may be stored at the central database 102 and promulgated to other users, as needed, for supervisory approval.

In certain embodiments, the workflow manager application 104 is responsible for synchronizing the workflows between the central database 102 and the workflow presentation application instances 106 as well as promulgating changes and reports, as needed, to certain ones of the workflow presentation application instances 106. In the embodiment shown, the workflow manager application 104 comprises a synchronization manager 104a that communicates with the workflow presentation application instances 106 and central database 102 to synchronize the workflows at both the workflow presentation application instances 106 and the central database 102. For example, if a user alters the workflow or a data structure associated with tasks or steps of the workflow in one of the workflow presentation application instances 106, the synchronization manager 104a may communicate that change to the central database 102, where the change is stored in the corresponding data structure. Likewise, synchronization manager 104a may synchronize the other workflow presentation application instances 106 with the updated workflow and data structures, so that each of the instances is viewing the real-time progress of the operation. In certain embodiments, the workflow manager application 104 and synchronization manager 104a may communicate with the central database 102 through XML Process Definition Language (XPDL) formatted transmissions 108.

In certain embodiments, the workflow manager application 104 may further comprise real-time audit/report block 104b that alerts users to and communicates audits or reports generated by one of the workflow presentation application instances 106 to other workflow presentation application instances 106 or users. Additionally, the workflow manager application 104 may comprise a monitor/notify block 104c that generates reminders for tasks and steps and otherwise monitors the progress of the operation. Monitor/notify block 104c may further transmit notifications to all or certain information handling systems that there have been updates to the workflow, when an audit or report is available, or when an action is needed to complete a task or step. For example, if a step requires managerial approval before it can be completed, the manager may be notified through their active workflow presentation application instance 106.

A workflow and corresponding data structures may be customized to the requirements of a particular operation while still incorporating industry standard tasks and steps. The workflows may be generated and stored in the database 102 before a job begins and may also be updated and modified as needed such that the major tasks and steps of the workflow are up-to-date with the latest industry standards. The updated workflow may be promulgated to the active workflow presentation application instances 106 using the workflow manager application 104. Notably, locating the workflow in the central database 102 makes it easier to promulgate changes to the workflow to the workflow presentation application instances 106.

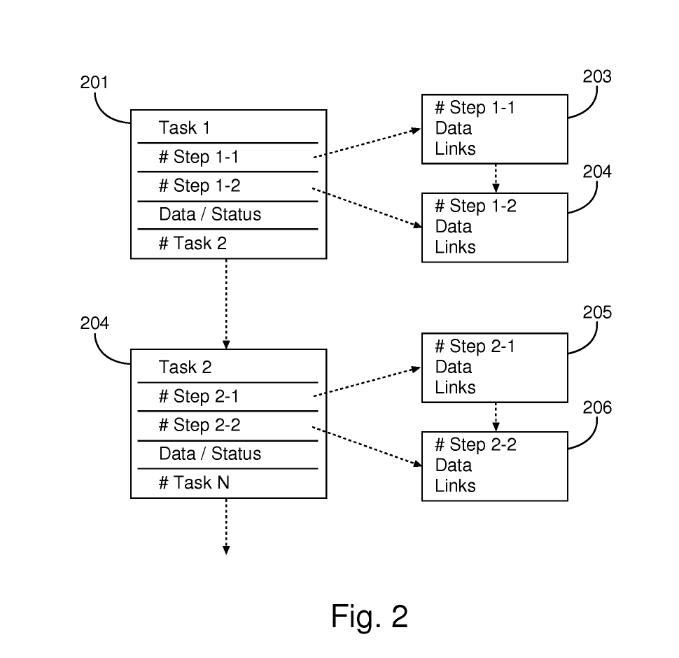

FIG. 2 is a diagram illustrating example workflow data structures, according to aspects of the present disclosure. In the embodiment shown, the data structures comprise task data structures 201 and 204 and corresponding step data structures 202 and 203, and 205 and 206, respectively. Each of the separate data structures may be stored within an information handling system. Data structures may be created, for example, when a workflow is generated or initialized, and may be modified/deleted/added as needed to update the workflow.

Data structure 201 corresponds to “Task 1” of a workflow. The data structure 201 may contain links or pointers “# Step 1-1” and “# Step 1-2” to data structures 202 and 203, respectively, corresponding to “Step 1-1” and “Step 1-2” of “Task 1.” The links or pointers “# Step 1-1” and “# Step 1-2” may comprise address pointers that indicate where in a storage system of an information handling system to access data structures 202 and 203 respectively. In addition to links or pointers to corresponding steps, data structure 201 may further comprise data regarding “Task 1,” including instructions, word files, text files, etc. Audits and reports about “Task 1” may be stored in the data field. The data may also comprise a status indicator that identifies the progress in completing “Task 1,” as will be described below. In certain embodiments, the data structure 201 may further comprise a link or pointer “#Task 2” to the data structure 204 for the next chronological task of the workflow, “Task 2.”

Data structure 202 corresponds to a first step, “Step 1-1,” of “Task 1” and may have a similar structure to the task data structure 201. For example, data structure 202 may comprise a data portion including instructions, word files, etc. as well as links to other data structures. In certain embodiments, the data structure 202 may comprise a link or pointer to the data structure 203 for the next chronological step “Step 1-2” of “Task 1,” which may have a similar structure to the data structure 202. In certain embodiments, the task data structure 201 may only include a link to the data structure of the first step of the task, and the data structures of the remaining steps may link to other steps in chronological order, with the data structure for the last step of the task, in this case data structure 203 for “Task 1-2,” including a link back to the task data structure.

Data structure 204 for “Task 2” and data structures 205 and 206 for “Step 2-1” and “Step 2-2,” respectively, may comprise similar information to the data structures 201-203. Notably, the number of tasks and steps in a given workflow may depend on the complexity of the workflow and tasks. For example, a particular workflow may comprise dozens of major tasks, with each of the tasks comprising multiple steps. The data structures described above may be scaled to accommodate different workflow configurations.

Modifying a data structure may comprise adding or changing data or information within the data structure. For example, a field engineer may modify the data structure may adding information about the associated step or “uploading” documents corresponding to a step, which may include storing the documents to a local information handling system or to a central database, and including a link or pointer within the data structure to the document. As described above, modifying the data structure may also be accomplished by altering a graphical representation of the data structure in a user interface, such as a check box or drop-down menu, where the graphical representation is associated with a data flag or state indicator in the data structure that is altered and when the graphical representation is altered.

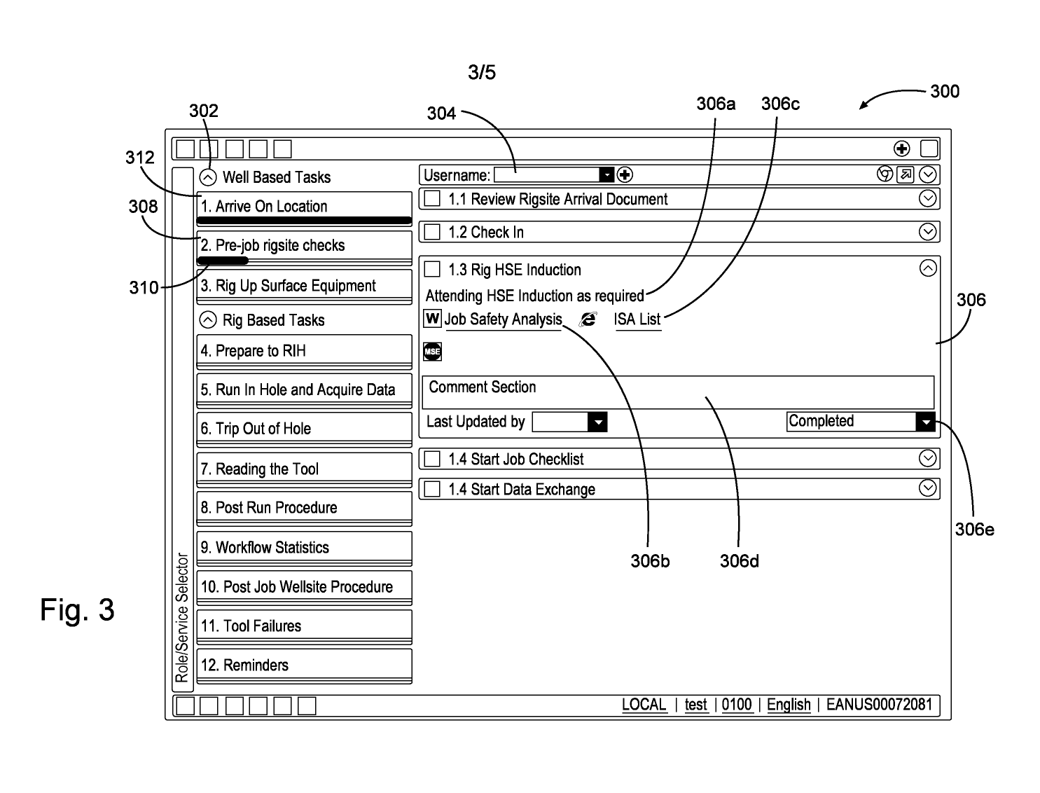

FIG. 3 illustrates an example user interface 300 of a workflow presentation application instance, according to aspects of the present disclosure. The user interface 300 may display graphical representations of a chronological list of the major tasks in a pane 302 and may display graphical representations of the steps corresponding to a selected major task in a right pane 304. Each of the graphical representations may correspond to data structures, and the information displayed with respect to the graphical representations of each of the major tasks and steps may be extracted from data and links stored within the corresponding data structures. For example, portion 306 of pane 304 comprises a selected step of a first task 308 and contains text instructions 306a as well as links 306b and 306c that a user may select to access important documentation. The portion 306 further includes a text input portion 306d in which a user may input notes regarding the step, and a status portion or drop-down menu 306e in which a user may identify that the step has been completed.

Each of the steps in the pane 304 may provide to a user, such as a field engineer, links to the necessary documentation to complete the corresponding step. For example, completing a step may require accessing or executing various word documents, software application, etc., and this may be accomplished by selecting links within the user interface. Additionally, some or all of the steps in the pane 304 may include warning icons or technical change notification documents that may alert a field engineer to new procedures.

In certain embodiments, each of the steps in pane 304 may have a corresponding status field, such as drop-down menu 306e, that may be modified to indicate that the step has been performed. Likewise, each of the major tasks in pane 302 may have at status indicator that shows the current progress on the major task. For example, major task 308 includes a status bar 310 that may be tied to the performance of the corresponding steps of the major task, and may indicate a percentage completion of the major task 308. Additionally, once a task or step has completed, the corresponding graphical representation may be altered to indicate completion, such as the color being changed on the graphical representation or major task 312. Notably, by incorporating status indicators, users may easily access and view the progress of a given operation.

In certain embodiments, the user interface 300 may vary depending on the user accessing the workflow. As described above, different users may have different user types, verified by login credentials, that limit what can be seen and modified in the workflow. In certain embodiments, those limitations may be implemented with respect to the user interface itself. For example, the user interface may provide a limited view or functionality for “customers” who may only view the workflow, displaying the graphical representations of the tasks and steps but excluding or hiding the additional data and links.

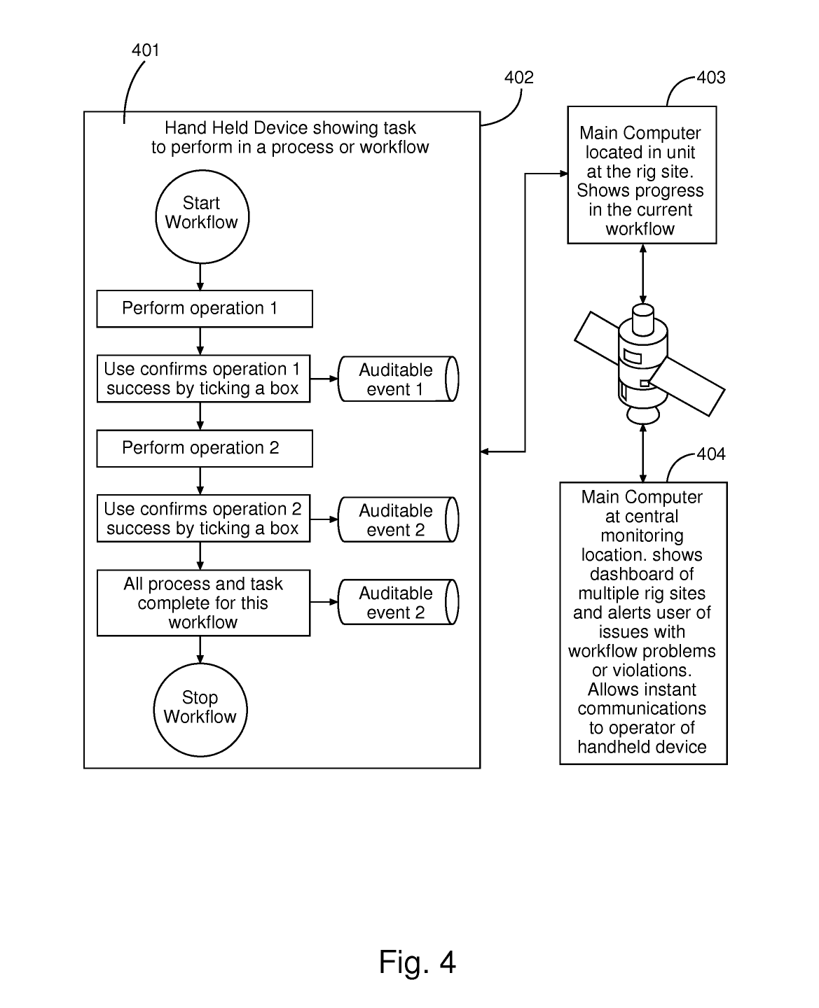

FIG. 4 is a flowchart illustrating an example workflow orchestration process according to aspects of the present disclosure. As described above, a workflow presentation application instance 401 may be run on a handheld information handling system 402 by an on-site field engineer. The handheld information handling system 402 may be communicably coupled, such as through a local wireless network, to an information handling system 403 also located on-site. The information handling system 403 may display the progress of the current workflow to an on-site supervisor, and may act as an intermediary between the handheld information handling system 402 and a central monitoring/management system 404, which may include a remote information handling system as well as a central database similar to the one described above. The remote information handling system may monitor workflows from multiple locations simultaneously.

The workflow presentation application instance 401 may provide a chronological list of major tasks and steps that must be completed as part of an operation. A field engineer may perform a particular major task or step in the workflow and indicate via the handheld device that the task or step has been completed. Completion of a task or step may generate an audit report that may be transmitted to the on-site information handling system 403 and finally to the central monitoring/management system 404. In certain embodiments, an audit report may include test reports or other data generated during performance of the task or steps. The field engineer may proceed with each of the tasks as they are presented on the handheld device, indicating completion at each step, at which point the various audit reports may be generated. The audit reports may be viewed by a manager through a second information handling system or handheld device, who may provide managerial approval or the completed step and indicate approval in the workflow, at which point the field engineer may proceed to the next step or major task. Accordingly, the workflow orchestration process may allow the field engineer to proceed in an orderly fashion through the tasks and steps, ensuring compliance with best practices, while providing a means to remotely and electronically monitor and audit the field engineer's actions.

In certain embodiments, the monitoring and auditing of the field engineer's actions may be at least partially automated. For example, at the completion of each step or task, the performance of the field engineer may be compared against pre-defined criteria. The central monitoring/management system 404 may generate messages or alerts based on the comparison, and may transmit those alerts through the on-site information handling system 403 to the handheld computing system 402, where the field engineer may respond accordingly. Likewise, the central monitoring/management system 404 may generate message or alerts for other events, including updates in best practices, etc.

Notably, the workflow architecture, including the visual representations in the user interface, may be used for numerous purposes. For example, a field engineer may use a handheld computing device to view a workflow representation in a user interface within the workflow architecture, retrieve data corresponding to a step within the workflow and to input data to the workflow and workflow architecture. The workflow architecture also may be used to verify the completion of tasks and to define the personnel responsible for certain tasks, the order in which the tasks are performed, and the manner in which the tasks are accomplished. For example, supervisors or customers may view the workflow through different computing systems to identify which tasks have been performed and to determine the overall status of the operation.

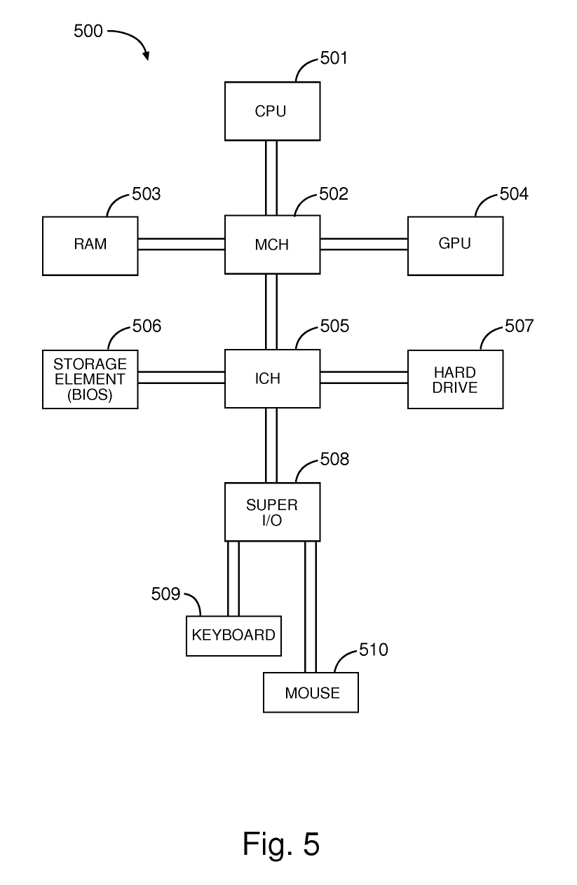

FIG. 5 is a block diagram showing an example information handling system 500, according to aspects of the present disclosure. A processor or CPU 501 of the information handling system 500 is communicatively coupled to a memory controller hub or north bridge 502. Memory controller hub 502 may include a memory controller for directing information to or from various system memory components within the information handling system, such as RAM 503, storage element 506, and hard drive 507. The memory controller hub 502 may be coupled to RAM 503 and a graphics processing unit 504. Memory controller hub 502 may also be coupled to an I/O controller hub or south bridge 505. I/O hub 505 is coupled to storage elements of the computer system, including a storage element 506, which may comprise a flash ROM that includes a basic input/output system (BIOS) of the computer system. I/O hub 505 is also coupled to the hard drive 507 of the computer system. I/O hub 505 may also be coupled to a Super I/O chip 508, which is itself coupled to several of the I/O ports of the computer system, including keyboard 509 and mouse 510.

According to aspects of the present disclosure, an example method for mobile workflow orchestration and job execution for a hydrocarbon recovery operation may include generating a workflow corresponding to the hydrocarbon recovery operation and providing the workflow to a first information handling system located at the site of the hydrocarbon recovery operation. The workflow may also be provided to a second information handling system remote from the site of the hydrocarbon recovery operation. Information regarding the workflow may be received from the first information handling system, and the workflow at the second information handling system may be updated based, at least in part, on the information received from the first information handling system.

In certain embodiments, generating the workflow corresponding to the hydrocarbon recovery operation may comprise generating a plurality of tasks to complete the hydrocarbon recovery operation and generating at least one step for each of the tasks. Receiving information regarding the workflow from the first information handling system may comprise receiving an indication that a task or step has been completed. Updating the workflow at the second information handling system based, at least in part, on the information received from the first information handling system may comprise updating a status indicator corresponding to the completed task or step. And receiving information regarding the workflow from the first information handling system may further comprise receiving at the second information handling system an audit report corresponding to the completed task or step.

In certain embodiments, the method may further comprise generating an updated workflow by adding or removing at least one task or step from the workflow, and providing the updated workflow in the first information handling system and the second information handling system. The method may further comprise transmitting to one of the first and second information handling systems an alert based, at least in part, on the workflow. And generating the workflow corresponding to the hydrocarbon recovery operation comprises storing in a database data structures associated with the tasks and steps; providing the workflow to the first information handling system comprises generating a first visual representation of the workflow in a first user interface of the first information handling system based, at least in part, on the data structures; and providing the workflow to the second information handling system comprises generating a second visual representation of the workflow in a second user interface of the second information handling system based, at least in part, on the data structures

In certain embodiments, the method may further include accessing at least one document corresponding to one of the tasks and steps through the first user interface, the at least one document stored in the database. And in certain embodiments, first information handling system comprises a handheld information handling system.

An example system for mobile workflow orchestration and job execution for a hydrocarbon recovery operation may include a database containing a workflow corresponding to the hydrocarbon recovery operation. A first information handling system may be located at the site of the hydrocarbon recovery operation and communicably coupled to the database. The first information handling system may contain a first set of instructions that, when executed by a first processor of the first information handling system, cause the first processor to generate a first visual representation of the workflow in a first user interface, receive information regarding the workflow through the first user interface, and transmit the received information to the database.

A second information handling system may be located remote from the site of the hydrocarbon recovery operation and communicably coupled to the database. The second information handling system containing a second set of instructions that, when executed by a second processor of the second information handling system, cause the second processor to generate a second visual representation of the workflow in a second user interface, and update the second visual representation based on the received information from the first information handling system. The workflow may comprise a plurality of tasks to complete the hydrocarbon recovery operation, and at least one step for each of the tasks. The information regarding the workflow may comprise an indication that a task or step has been completed.

In certain embodiments, the updated second visual representation in the second information handling system may comprise a status indicator corresponding to the completed task or step. The updated second visual representation in the second information handling system may comprise a link to an audit report corresponding to the completed task or step. The second set of instruction further may cause the second processor to receive an alert based, at least in part, on the workflow.

In certain embodiments, the database may comprise data structures associated with the tasks and steps; the first visual representation is based, at least in part, on the data structures; and the second visual representation is based, at least in part, on the data structures. The data structures may comprise documents corresponding to the associated tasks and steps. The first set of instructions may further cause the first processor to receive at least one document selection through the first interface; and display the selected document. In certain embodiments, the first information handling system may comprise a handheld information handling system.

Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered or modified and all such variations are considered within the scope and spirit of the present invention. Also, the terms in the claims have their plain, ordinary meaning unless otherwise explicitly and clearly defined by the patentee. The indefinite articles “a” or “an,” as used in the claims, are each defined herein to mean one or more than one of the element that it introduces.

What is claimed is:

1. A method for mobile workflow orchestration and job execution for a hydrocarbon recovery operation, comprising:
generating a workflow corresponding to the hydrocarbon recovery operation;
providing the workflow to a first information handling system located at the site of the hydrocarbon recovery operation;
providing the workflow to a second information handling system remote from the site of the hydrocarbon recovery operation;
receiving information regarding the workflow from the first information handling system; and
updating the workflow at the second information handling system based, at least in part, on the information received from the first information handling system.

2. The method of claim 1, wherein generating the workflow corresponding to the hydrocarbon recovery operation comprises
generating a plurality of tasks to complete the hydrocarbon recovery operation; and
generating at least one step for each of the tasks.

3. The method of claim 2, wherein receiving information regarding the workflow from the first information handling system comprises receiving an indication that a task or step has been completed.

4. The method of claim 3, wherein updating the workflow at the second information handling system based, at least in part, on the information received from the first information handling system comprises updating a status indicator corresponding to the completed task or step.

5. The method of claim 4, wherein receiving information regarding the workflow from the first information handling system further comprises receiving at the second information handling system an audit report corresponding to the completed task or step.

6. The method of claim 2, further comprising
generating an updated workflow by adding or removing at least one task or step from the workflow; and
providing the updated workflow in the first information handling system and the second information handling system.

7. The method of claim 2, further comprising transmitting to one of the first and second information handling systems an alert based, at least in part, on the workflow.

8. The method of claim 2, wherein
generating the workflow corresponding to the hydrocarbon recovery operation comprises storing in a database data structures associated with the tasks and steps;
providing the workflow to the first information handling system comprises generating a first visual representation of the workflow in a first user interface of the first information handling system based, at least in part, on the data structures; and
providing the workflow to the second information handling system comprises generating a second visual representation of the workflow in a second user interface of the second information handling system based, at least in part, on the data structures

9. The method of claim 8, further comprising accessing at least one document corresponding to one of the tasks and steps through the first user interface, the at least one document stored in the database.

10. The method of claim 8, wherein the first information handling system comprises a handheld information handling system.

11. A system for mobile workflow orchestration and job execution for a hydrocarbon recovery operation, comprising:
a database containing a workflow corresponding to the hydrocarbon recovery operation;
a first information handling system located at the site of the hydrocarbon recovery operation and communicably coupled to the database, the first information handling system containing a first set of instructions that, when executed by a first processor of the first information handling system, cause the first processor to
generate a first visual representation of the workflow in a first user interface;
receive information regarding the workflow through the first user interface; and
transmit the received information to the database; and
a second information handling system located remote from the site of the hydrocarbon recovery operation and communicably coupled to the database, the second information handling system containing a second set of instructions that, when executed by a second processor of the second information handling system, cause the second processor to
generate a second visual representation of the workflow in a second user interface; and
update the second visual representation based on the received information from the first information handling system.

12. The system of claim 11, wherein the workflow comprises
a plurality of tasks to complete the hydrocarbon recovery operation; and
at least one step for each of the tasks.

13. The system of claim 12, wherein the information received regarding the workflow comprises an indication that a task or step has been completed.

14. The system of claim 13, wherein the updated second visual representation in the second information handling system comprises a status indicator corresponding to the completed task or step.

15. The system of claim 14, wherein the updated second visual representation in the second information handling system comprises a link to an audit report corresponding to the completed task or step.

16. The system of claim 12, wherein the second set of instruction further causes the second processor to receive an alert based, at least in part, on the workflow.

17. The system of claim 12, wherein
the database comprises data structures associated with the tasks and steps;
the first visual representation is based, at least in part, on the data structures; and
the second visual representation is based, at least in part, on the data structures

18. The system of claim 17, wherein the data structures comprise documents corresponding to the associated tasks and steps.

19. The system of claim 18, wherein the first set of instructions further causes the first processor to
receive at least one document selection through the first interface; and
display the selected document.

20. The system of claim 11, wherein the first information handling system comprises a handheld information handling system.
